(19) United States
(12) Patent Application Publication
(10) Pub. No.: US 2023/0227365 A1
(43) Pub. Date: Jul. 20, 2023

(54) Sacrificial Ceramic CO2 Sequestration Panels

(71) Applicants: David Nowacek, San Antonio, TX (US); Brian Gorman, Golden, CO (US)

(72) Inventors: David Nowacek, San Antonio, TX (US); Brian Gorman, Golden, CO (US)

(21) Appl. No.: 18/098,100

(22) Filed: Jan. 17, 2023

Related U.S. Application Data
(60) Provisional application No. 63/299,720, filed on Jan. 14, 2022.

(51) Int. Cl. C04B 35/16; C04B 35/64; C04B 41/53; C04B 41/00; C04B 38/00

(52) U.S. Cl. CPC C04B 35/16; C04B 35/64; C04B 38/0074; C04B 41/0072; C04B 41/5307; C04B 2235/96; C04B 2235/728; C04B 2235/784; C04B 2235/786

(57) ABSTRACT

A sacrificial ceramic CO₂ sequestration architectural product comprising a sintered/heat-treated mixture that comprises: one or more reactive solid phases, wherein each reactive solid phase comprises one or more weathering materials capable of enhanced mineralization, and one or more particle-bridging phases that bridge the one or more reactive solid phases, and an open porosity that is in a range from about 15 vol% to about 30 vol%.

### CROSS-REFERENCE TO RELATED APPLICATIONS

The present application is a non-provisional application claiming the benefit of U.S. Pat. Ser. No. 63/299,720, filed Jan. 14, 2022, which is incorporated herein by reference in its entirety.

### FIELD OF THE INVENTION

Architectural products that sequester atmospheric carbon dioxide due to enhanced weathering.

### BACKGROUND OF INVENTION

Build-up of greenhouse gas in Earth’s atmosphere has resulted in climate change. We are confronted with the effects of climate change all over the world. Carbon dioxide (CO₂) is a main constituent of greenhouse gas.

Mineral CO₂ weathering (or sequestration) is a greenhouse gas mitigation strategy whereby CO₂ is removed from the atmosphere by binding it with metallic silicate minerals containing calcium or magnesium.

Weathering of these minerals produces harmless bicarbonates which are deposited in soils or carried by rivers to the sea where shellfish and corals convert them to carbonate rocks like limestone and dolomite. This process offers a permanent conversion or sequestration of CO₂ versus a temporary storage solution. This weathering is accomplished by CO₂ captured in rainwater forming a weak carbonic acid (carbonated water) that reacts with and dissolves basic rocks and minerals, especially those containing silicate, calcium and magnesium, such as olivine.

Mineral weathering is a natural process of capturing atmospheric CO₂. In fact, it is the only process that has captured billions of tons of CO₂ during Earth’s history. The weathering process gradually wears down the mineral-containing surface as the reaction is destructive at the microscopic level.

A need exists for products that increase the availability and exposure of these minerals to the environment on a large scale.

### SUMMARY OF INVENTION

In one embodiment, the invention is directed to a sacrificial ceramic CO₂ sequestration architectural product comprising a sintered/heat-treated mixture. The sintered/heat-treated mixture comprises:
one or more reactive solid phases at a total relative amount in a range from about 30 wt% to about 70 wt% of the sintered/heat-treated mixture, wherein each reactive solid phase comprises one or more weathering materials, wherein each weathering material is Mg—, Ca—, and/or Na-rich (greater than 40 atomic % of the cations of the weathering materials), Si-poor (less than 55 atomic % of the cations of the weathering materials), and capable of enhanced mineralization, and wherein each reactive solid phase has a median grain size in a range from about 10 µm to about 500 µm and a single mode grain size distribution such that one standard deviation is ± 10% of the median grain size; and
one or more particle-bridging phases that bridge the one or more reactive solid phases, wherein the one or more particle-bridging phases are at a total relative amount in a range from about 30 wt% to about 70 wt% of the sintered/heat-treated mixture; and
an open porosity (determined by ASTM C830) that is in a range from about 15 vol% to about 30 vol%.

In one embodiment, the present invention is directed to a process for making the sacrificial ceramic CO₂ sequestration architectural product that comprises a sintered/heat-treated mixture. The process comprising: creating a mixture that comprises:
particles of one or more weathering materials and a binder, wherein the one or more weathering materials are at total relative amount that is in a range from about 30 wt% to about 70 wt% of the mixture solids, and wherein each weathering material is Mg—, Ca—, and/or Na-rich (greater than 40 atomic % of the cations of the weathering materials) and Si-poor (less than 55 atomic % of the cations of the weathering materials), and capable of enhanced mineralization, and wherein each weathering material has a median particle size in a range from about 10 µm to about 500 µm and a single mode particle size distribution (determined using sieve (ASTM C371-09), microscopy (ISO 13322-2), or laser scattering (ASTM 1070-01 or ISO 13320-1)) such that one standard deviation is ± 10% of the median grain size; and
particles of one or more bridging materials, wherein the one or more bridging materials are at total relative amount that is in a range from about 30 wt% to about 70 wt% of the mixture solids, and wherein the one or more bridging materials are selected from the group consisting of one or more clays, one or more feldspars, quartz, corundum, one or more soda lime glasses, one or more other glasses, combinations thereof.

The process further comprising forming the mixture and heating the formed mixture to yield the sintered/heat-treated mixture, wherein the sintered/heat-treated mixture comprises:
one or more reactive solid phases at a total relative amount in a range from about 30 wt% to about 70 wt% of the sintered/heat-treated mixture, wherein each reactive solid phase comprises one or more weathering materials, wherein each weathering material is Mg—, Ca—, and/or Na-rich (greater than 40 atomic % of the cations of the weathering materials), Si-poor (less than 55 atomic % of the cations of the weathering materials), and capable of enhanced mineralization, and wherein each reactive solid phase has a median grain size in a range from about 10 µm to about 500 µm and a single mode grain size distribution such that one standard deviation is ± 10% of the median grain size; and
one or more particle-bridging phases that bridge the one or more reactive solid phases, wherein the one or more particle-bridging phases are at a total relative amount in a range from about 30 wt% to about 70 wt% of the sintered/heat-treated mixture; and
an open porosity (determined by ASTM C830) that is in a range from about 15 vol% to about 30 vol%.

### BRIEF DESCRIPTION OF THE DRAWINGS

FIG. 1 contains photographic images of ceramic CO2 sequestration products configured to be stone and decorative stone tile, both with relatively rough surfaces.

FIG. 2 is photographic image of a ceramic CO2 sequestration product that is a large format tile configured to have a decorative mosaic appearance.

FIG. 3 contains photographic images of ceramic CO2 sequestration product configured to be a decorative stone tile with a relatively smooth surface.

### DETAILED DESCRIPTION OF INVENTION

CO₂-sequestering architectural products (e.g., panels, tiles, bricks/pavers, etc.) composed of materials rich in reactive minerals such as olivine have the potential to reduce millions of tons of carbon dioxide from the atmosphere. Such architectural products may be placed on or used to form a horizonal surface (e.g., a floor or walkway) or a vertical surface such as a wall cladding. Such products may also be placed on used as roofing materials (flat or sloped).

### General Description of a Process for Making a Ceramic CO₂ Sequestration Architectural Product

In general, the process involves creating a mixture of suitable ingredients at suitable relative amounts for the particular end use or application, forming the mixture in the desired type of product such as a tile, brick, paver, etc. (e.g., via extrusion or another appropriate technique), and heating the formed mixture to yield a sintered or heat-treated mixture that is a ceramic capable of CO₂ sequestration. The mixture of ingredients typically comprises a binder that is lost in drying and/or heat-treating the formed mixture. Such binder include water and/or conventional organic binder compounds used to aid in mixing, forming, and to impart adequate “green” strength to the formed mixture.

Unlike conventional architectural or building products which are specifically designed for longevity, CO₂ sequestration products of the present invention are designed to deteriorate. The rate of deterioration depends on a variety of factors, including composition, particle size, surface area, porosity, etc.

In certain embodiments of the present invention, the CO₂ sequestration architectural products may have mechanical properties (e.g., strength, density, hardness, and water absorption) that are considered lesser compared to a corresponding conventional building product but that is too be expected because they are designed to be “sacrificial.” They are intended to be less durable than conventional products and to weather-away over the life of the product.

Further, in certain embodiments, the CO₂ sequestration architectural products of the present invention may be formulated and produced to optimize environmental degradation at the expense of structural properties. In fact, the CO₂ sequestration architectural products of the present invention may be designed to be non-structural, nondurable, and weather-away as fast as possible. In such embodiments, mechanical strength and low water absorption need only be sufficient to maintain tile integrity during the life of product. Such CO₂ sequestration architectural products will typically be formulated to have relatively high amounts of reactive solids to maximize the CO reaction activity at the expense of strength and longevity.

### Ingredients of the Ceramic CO₂ Sequestration Architectural Products

The purpose of this invention is to replace or substitute some ingredients in architectural products (e.g., panels, tiles, bricks/pavers, etc.) that provide no direct environmental benefit related to CO₂. In contrast the ceramic CO₂ sequestration architectural products of the present invention are believed, over their useful life, to have a “net negative” CO₂ footprint even factoring in the CO₂ produced as a byproduct of the manufacturing process, transportation, and installation.

### Weathering Materials

In view of the foregoing, the present invention is directed to producing sacrificial ceramic CO₂ sequestration architectural products from materials that are capable of “enhanced mineralization” when installed (referred to herein as “weathering materials”). “Enhanced mineralization” (also known as enhanced weathering or accelerated weathering) is a carbon dioxide removal approach that uses technologies or modified land-use approaches to accelerate the decomposition of calcium- and magnesium-rich silicate rocks, which chemically react with CO₂ to form solid carbonate minerals, resulting in the removal of CO₂ from the atmosphere (https://netl.doe.gov/carbon-dioxide-removal).

In general, suitable weathering materials tend comprise magnesium, calcium, and/or sodium in relatively high amounts. Stated another way, suitable weathering materials are considered to be Mg—, Ca—, and/or Na-rich. For example, the concentration of Mg, Ca, Na, and combinations thereof tends to be greater than 40 atomic % of the cations of any weathering material. Additionally, suitable weathering materials tend to have relatively low amounts of silicon or are considered to be Si-poor. For example, the concentration of Si tend to be less than 55 atomic % of the cations of any weathering material.

In one embodiment, a mixture of constituents used to produce a sacrificial ceramic CO₂ sequestration architectural product comprises one or more weathering materials selected from the group consisting of olivine ((Mg,Fe)₂SiO₄), forsterite (Mg₂SiO₄), monticellite (CaMgSiO₄), calarnite (Ca₂SiO₄), wollastonite (CaSiO₃), merwinite (Ca₃MgSi₂O₈), bredigite (Ca₇MgSi₄O₁₆), basalts, other ultramafic minerals as defined/classified by the International Union of Geological Sciences (IUGS), and combinations. It is worth noting that olivines are considered to be ultramafic minerals; so, “other” ultramafic minerals include, for example, pyroxenes.

### Olivine

Olivine, which is primarily forsterite (Mg₂SiO₄), is widely known as one of the least stable silicate minerals. It has a high magnesium content and low-cost reserves exist around the world. Thus, olivine is a particularly desirable reactive solid (RS) for inclusion in CO₂ sequestration ceramic products. Olivine can convert CO₂ at a weight ratio of 1:1 or more. For example a product containing five pounds of olivine may remove five pounds or more of CO₂ over the life of the product as it weathers. The rate of weathering is dependent on may factors such as the composition of the atmosphere at the installed location, amount of rainfall, temperature, humidity, etc.

Olivine, which is rich in magnesium, has a higher melting point and therefor a higher sintering temperature than most of the typical ceramic ingredients in order to achieve the desired (strong) mechanical properties.

Olivine ore also contains iron and other trace minerals which typically limits its inclusion in conventional finished tile products. In particular, trace minerals like FeO may affect the mechanical strength and porosity or may cause a discoloration of finished tiles. These color and strength effects are not likely to present problems of the products of the present invention.

If the ingredient mixture of conventional tile compositions are modified to contain olivine, a higher sintering temperature and/or soak time is likely necessary to obtain the desired strength, hardness, density, and water absorption. Such an increased firing time and temperature increases energy consumption and produces more CO₂.

Due to the desired properties of conventional ceramic tiles as a durable building product and the desire to maintain or reduce firing (sintering) temperatures, the relative amounts of olivine, if any is included in a mixture, have been limited (e.g., less than 40% of the total by weight of the mixture.

### Relative Amount Weathering Materials

The mixture of ingredients used produce a sacrificial ceramic CO₂ sequestration architectural product comprises the weathering material(s) at amounts sufficient to result in a significant amount of carbon mineralization or CO₂ sequestration over the like of the product. In general, a mixture that total relative amount of the one or more weathering materials in a range from about 30 wt% to about 70 wt% of the solids in the mixture. In another embodiment, the total relative amount of the one or more weathering materials is in a range from about 50 wt% to about 70 wt% of the solids in the mixture.

### Particle Sizes of the Weathering Materials

As indicated above, the size of the particles of the ingredients of the sacrificial ceramic CO₂ sequestration architectural product affects the rate at which carbon mineralization reaction occurs. In general, the rate of reaction tends to increase as the sizes of weathering materials particles decrease.

In one embodiment, the particles of the weathering material(s) of the mixture have a median particle size in a range from about 10 µm to about 500 µm and a single mode particle size distribution (determined using sieve (ASTM C371-09), microscopy (ISO 13322-2), or laser scattering (ASTM 1070-01 or ISO 13320-1)) such that one standard deviation is ± 10% of the median grain size. In one embodiment, the particles of the weathering material(s) of the mixture have median particle size in a range from about 10 µm to about 100 µm. In one embodiment, the particles of the weathering material(s) of the mixture median particle size in a range from about 100 µm to about 200 µm. In one embodiment, the particles of the weathering material(s) of the mixture median particle size in a range from about 200 µm to about 500 µm.

### Bridging Materials

The mixture further comprises particles of one or more bridging materials selected from the group consisting of one or more clays, one or more feldspars, quartz, corundum, one or more soda lime glasses, one or more other glasses, combinations thereof.

In such embodiments, the relative total amount of the bridging materials in a range from about 30 wt% to about 70 wt% of the mixture for forming a desirable sacrificial ceramic CO₂ sequestration architectural product. In one embodiment, the one more bridging materials are at a total relative amount that is in a range from about 50 wt% to about 70 wt% of the mixture solids.

In one embodiment, the one or more bridging materials is one or more clays.

In one embodiment, the one or more bridging materials is a combination of one or more clays and one or more feldspars. In another such embodiment, the combination of one or more clays and one or more feldspars has a relative amount of the one or more clays that is in a range from about 50 wt% to about 67 wt% of the combination and a relative amount of the one or more feldspars that is in a range from about 33 wt% to about 50 wt% of the combination.

In one embodiment, the one or more bridging materials is one or more glasses. In another such an embodiment, the one or more bridging materials is one or more soda lime glasses.

Glasses may be particularly desirable for making ceramic CO₂ sequestration architectural products that are glass-ceramics due to the relatively low softening temperatures of many glass compositions, including conventional soda lime glasses. As a result, lower heat-treatment temperatures for preparing such a ceramic CO₂ sequestration architectural product while adequately bridging weathering materials such as olivine and yielding a product with a desirable porosity result in lower CO₂ emissions and energy usage in the production.

Advantageously, glass compositions such soda lime glass tend to weather and would be expected to contribute to the CO₂ sequestration. If some resistance to weathering is desired, for example, to extend/slow the sequestration, glasses such fused silica and borosilicate glass may be included.

### Body Colorants

Trace minerals may be added to the mixture prior to firing to achieve a desired color-body throughout the thickness of the panel.

### Olivine-Containing Porcelain and Ceramic Tiles

Conventional ceramic tiles and panels are made of various raw materials such as clays, quartz, feldspar and other trace minerals. A typical proportional mixture of these raw materials is: 40-60% clays, 30-40% feldspar and 10-30% quartz. Another formulation, in particular for porcelains is about 50 wt% kaolin, about 25 wt% feldspar, and about 25 wt% quartz. They are typically fired at temperatures from 1000 to 1300° C. with porcelains typically fired at higher temperatures and made with high quality ingredients. The compositions of the present invention may also be used to produce bricks and pavers, which are of similar compositions but the ingredients tend to be of lesser quality and cost.

In one embodiment, a sacrificial ceramic CO₂ sequestration architectural product may be based on a conventional porcelain/ceramic composition but with one or more of the conventional ingredient (e.g., quartz) replaced with olivine or other weathering compounds. In such an olivine-containing “porcelain” embodiment, the quartz would be replaced with olivine. It is to be noted that conventional porcelains are typically fired at about 1,440° C., which sufficiently high to result in the degradation of olivine into crystallographic phases that are not susceptible to atmospheric carbon mineralization or weathering. But because the sacrificial ceramic CO₂ sequestration architectural product of the present may be produced to favor CO₂ sequestration over mechanical properties, the sintering/heat-treatment temperature may be reduce to a value sufficiently low to avoid such degradation of the olivine (e.g., at 1280° C.).

### Surface Texture of the Sintered Architectural Product

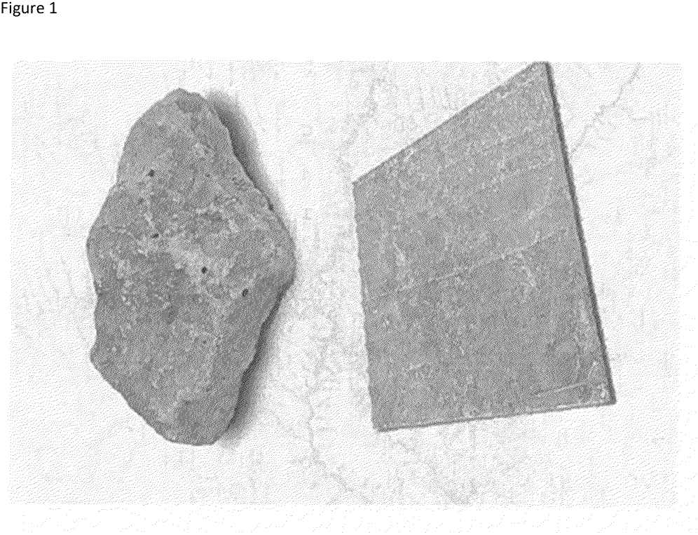

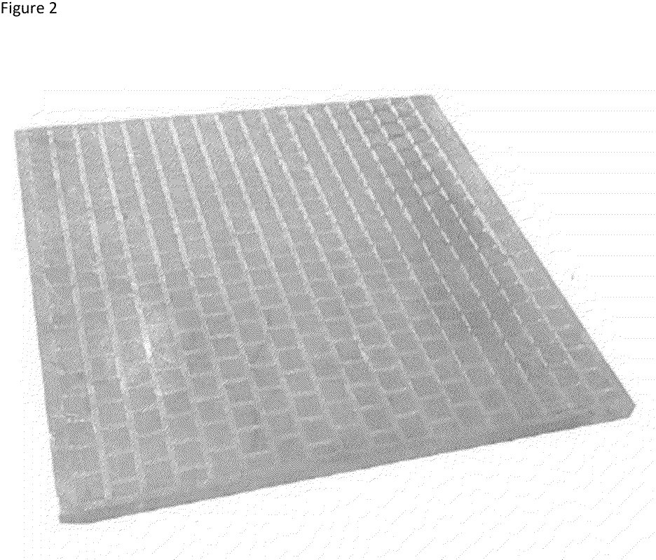

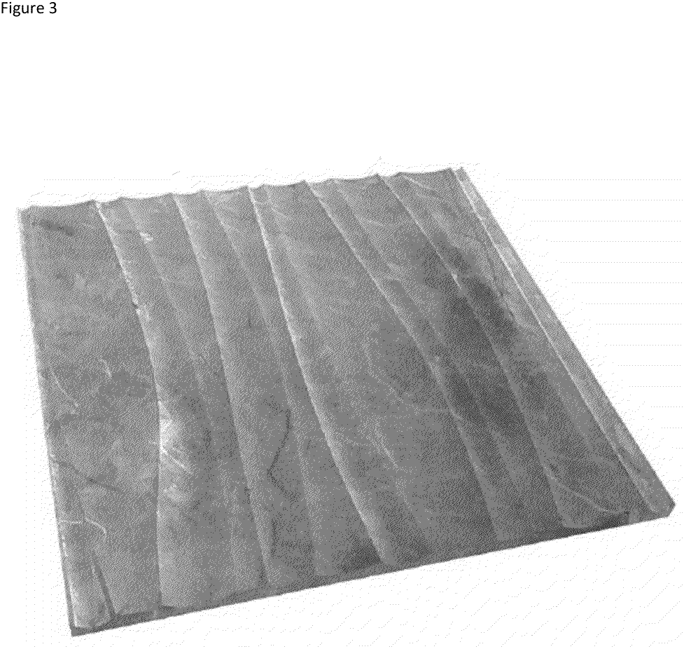

Prior art ceramic tiles are typically smooth or have little surface texture. This is to maintain a smooth, easy-to-clean, hygienic surface. A smooth surface is also is less likely to chip or crack. In contrast, the surface of products according to the present invention need not be smooth and in certain embodiments are a rough as possible in order to increase surface area and, therefore, offer increased reaction area. Regular or irregular geometric patterns, random or repeated textures consisting of embossed or debased areas help increase surface area. Textures or patterns pressed into the green panels before firing may extend to the top surface, side edges and bottom surface to encourage water flow to all areas of the panel. This increased surface texture increases the CO₂ removal reaction by exposing more olivine to the CO₂-containing rain water. Examples of such increased surface texture products (compared to conventional smooth ceramic tiles) are depicted in FIGS. 1-3.

Some embodiments of the CO₂ sequestration products have heavily textured surfaces to increase the area available for reaction with rain water and provide a greater reduction of atmospheric CO₂. In one such embodiment, the forming of the mixture comprises configuring the formed mixture so that the sintered/heat-treated mixture has at least one major surface configured to have an effective surface area that is in a range from 20% to about 100% greater than a nominal macroscale area of said at least one major surface. In another such embodiment, the forming of the mixture comprises configuring the formed mixture so that the sintered/heat-treated mixture has at least one major surface configured to have an effective surface area that is in a range from 30% to about 70% greater than a nominal macroscale area of said at least one major surface.

In addition to enhancing the surface area, the forming of the mixture comprises configuring the formed mixture so that the sintered/heat-treated mixture is configured for installation with ceramic panel fasteners, screws, or nails.

### Temperature

The sintering/heat treatment should be conducted at temperature(s) sufficiently high for densification and microstructure development of the sintered/heat-treated mixture but not so high as to degrade the weather materials’ susceptibility to atmospheric carbon mineralization. But the process of producing a sacrificial ceramic CO₂ sequestration architectural product from a mixture comprising weathering material(s) should not be conducted at temperatures capable of decomposing a significant portion of the weathering materials (e.g., temperature in excess of 1,350° C. degrade olivine) into crystallographic phases that are not susceptible to atmospheric carbon mineralization or weathering such as enstatite ((Mg,Fe)SiO₃ and periclase ((Mg,Fe)O). Thus, it is desirable to select a temperature the formed mixture is heated to temperature(s) in a range from about 900° C. to about 1125° C. for a duration in a range from about 4 hours to about 48 hours.

### The Sintered/Heat-Treated Mixture

Upon being subjected to the heat treatment, the sintered/heat-treated mixture comprises one or more reactive solid phases and one or more particle-bridging phases that bridge the one or more reactive solid phases.

In one embodiment, sacrificial ceramic CO₂ sequestration architectural product comprises the sintered/heat-treated mixture.

In one embodiment, sacrificial ceramic CO₂ sequestration architectural product consists of the sintered/heat-treated mixture.

The relative amount of the reactive solid phases generally correspond to the relative amount of the weathering materials in included in the mixture. As such, in one embodiment, the relative amount of the reactive solid phases is in a range from about 30 wt% to about 70 wt% of the sintered/heat-treated mixture. In another embodiment, the relative amount of the reactive solid phases is in a range from about 50 wt% to about 70 wt% of the sintered/heat-treated mixture.

### Composition of the Reactive Solid Phases

Additionally, the composition and sizes of the reactive solid phases generally correspond to relative amounts of the weathering materials and their particle sizes. As such, the weathering material is Mg—, Ca—, and/or Na-rich (greater than 40 atomic % of the cations of the weathering materials) and Si-poor (less than 55 atomic % of the cations of the weathering materials), and capable of enhanced mineralization.

In one embodiment, the one or more reactive solid phases comprise magnesium, calcium, and/or sodium at a total concentration in a range from about 40 atomic % to about 100 atomic % of the cations of the reactive solid phases.

In one embodiment, the reactive solid phases are selected from the group consisting of olivine ((Mg,Fe)₂SiO₄), forsterite (Mg₂SiO₄), monticellite (CaMgSiO₄), calarnite (Ca₂SiO₄), wollastonite (CaSiOs), merwinite (Ca₃MgSi₂O₈), bredigite (Ca₇MgSi₄O₁₆), basalts, other ultramafic minerals (as defined by the International Union of Geological Sciences), and combinations thereof.

In one embodiment, the reactive solid phases is olivine ((Mg,Fe)₂SiO₄).

### Size of the Crystalline Reactive Solid Phase Grains

In one embodiment, the reactive solid phase grains of the sintered/heat-treated mixture have a median grain size in a range from about 10 µm to about 500 µm and a single mode grain size distribution such that one standard deviation is ± 10% of the median grain size. Such a quantification may be determined using microscopy. In one embodiment, the reactive solid phase grains of the sintered/heat-treated mixture a median grain size in a range from about 10 µm to about 100 µm. In one embodiment, the reactive solid phase grains of the sintered/heat-treated mixture a median grain size in a range from about 100 µm to about 200 µm. In one embodiment, the reactive solid phase grains of the sintered/heat-treated mixture a median grain size in a range from about 200 µm to about 500 µm.

### Porosity of the Sintered/Heat-Treated Mixture

In order to sequester carbon dioxide, there needs to be interaction between air and/or water containing CO₂ and reactive solids. In general, a porosity in a range of about 15 vol% to about 30 vol% (determined by ASTM C830) is considered desirable for CO₂ sequestration as long as the negative impact on mechanical properties prevents the product from its intended use. As such the porosity of the present CO₂ sequestration products may be engineered to have porosities necessary to achieve a desired rate for carbonation reactions.

### Particle-Bridging Phase(s)

The sintered/heat-treated mixture of a sacrificial ceramic CO₂ sequestration architectural product comprises one or more particle-bridging phases that bridge the one or more reactive solid phases. These phases generally result from heat treatment of the above-described bridging materials. As such, the one or more particle-bridging phases comprise one or more bridging materials selected from the group consisting of one or more clays, one or more feldspars, quartz, corundum, one or more soda lime glasses, one or more other glasses, combinations thereof, and reaction products thereof.

In one embodiment, the one or more particle-bridging phases comprise bridging materials selected from the group consisting of one or more clays and reaction products thereof.

In one embodiment, the one or more particle-bridging phases comprise bridging materials selected from the group consisting of a combination of one or more clays and one or more feldspars, and reaction products of said combination. In one such an embodiment, the combination of one or more clays and one or more feldspars is such that the combination has a relative amount of the one or more clays that is in a range from about 50 wt% to about 67 wt% of the combination and a relative amount of the one or more feldspars that is in a range from about 33 wt% to about 50 wt% of the combination.

In one embodiment, the one or more particle-bridging phases comprise bridging materials selected from the group consisting of one or more soda lime glasses, and reactions products of said one more soda lime glasses.

### Surface Glazes

The products of the present invention may have a glazed surface made of a typical ceramic color engobe, primer, and/or surface coat applied prior to firing on one side of the panel to impart a color. This produces a panel that may be installed so the colored surface is visible to achieve a particular color of floor, wall or roof, yet still remove CO₂ by rainwater flowing on the other sides or surfaces of the panel.

### Securing and Sealing the CO2 Sequestration Architectural Product

Conventional ceramic tiles are designed to be installed with mortar, adhesive, or other mastic on the bottom of the tile to hold it in place. Additionally, to reduce water infiltrating under the surface of convention tiles and causing the system to fail, a waterproof grout is typically used in and along the joint between adjoining tiles.

In certain embodiment, tiles and panel of the present invention may be installed without mortar on the mounting side or grout between panels to increase water flow all over and under the panel. For example, such panels may be large patio paver-sized and installed on a relatively flat surface and secured with gravity. Alternatively, such panels may be hung on a wall or secured on a roof using nails, screws, or other fasteners.

CO₂ sequestration panels may be may be applied over a waterproofing underlayment. The purpose of the underlayment is to protect the underlying surface from rain water which is directed to the bottom surface of the panel by textures on the top and side edges of the panel.

Certain embodiment of CO₂ sequestration panels may lack the structural integrity of a typical ceramic building product. Hook-type hangers at the top, side and bottom edges of the may be employed to hold such panels in place to enable easy installation and replacement as panels wear-out (see, e.g., U.S. Pat. No. 9,926,704, which is incorporated by reference herein in its entirety).

### EXAMPLES

### Example 1 - Ceramic Tile

Compositions and heat treating protocols (aka firing or sintering) were evaluated for producing a ceramic tile containing olivine as the reactive solids.

Commercial olivine was acquired and was determined to be forsterite (Mg₂SiO₄) with nominally 8% fayalite (Fe₂SiO₄). The particle size distribution of the olivine was single mode centered around 200 µm.

One composition had a dry mixture comprising about 80 wt% olivine and about 20 wt% commercial red clay (Cedar Heights Red Art) with a nominal particle size of 2 µm and good flowability. Another composition had a dry mixture comprising about 70% wt% olivine, about 20 wt% red clay, and about 10 wt% nepheline syenite (Laguna Clay Co.) with a nominal particle size of less than 37 µm. Yet another composition had a dry mixture comprising about 70 wt% olivine, about 20 wt% red clay, and about 10 wt% potash feldspar (Laguna Clay Co.) with a nominal particle size of less than 74 µm. The substitutions of about 10 wt% of olivine with nepheline syenite or K-spar were intended to evaluate compositions that could be adequately heat treated at lowering sintering temperatures compared to the foregoing 80-20 dry composition.

The dry mixtures were subsequently mixed on a ball mill for 24 hr with 1.5 wt% water to act as a binder to add green strength to the formed body. Approximately 5 g of the wet mixtures were used to form solid green bodies (cylinders with 2.5 cm in diameter) via uniaxial pressing at about 300 MPa. The green bodies were heat treated in an electric kiln at 1280° C. for 2 hours. After heat treatment, the samples exhibited a water absorption of about 6%, per ASTM C373-18. X-ray diffraction analyses confirmed that forsterite was still the primary solid phase after heat treatment, along with minor amounts of quartz and hematite. Additional experiments sintering these compositions at temperatures between 1,350° C. and 1,440° C. resulted in a highly vitrified morphology, dark red to black colors, and a decomposition of the olivine into other crystallographic phases such as enstatite and periclase.

### Example 2 - Ceramic Brick/Paver

A composition and heat treating protocol (aka firing or sintering) was evaluated for producing a ceramic brick or paver containing olivine as the reactive solids.

Commercial olivine was acquired and was determined to be forsterite (Mg₂SiO₄) with nominally 8% fayalite (Fe₂SiO₄). The particle size distribution of the olivine was single mode centered around 200 µm.

One composition had a dry mixture comprising about 70 wt% olivine and about 30 wt% commercial red clay (Cedar Heights Red Art) with a nominal particle size of 2 µm and good flowability. The dry mixture was subsequently mixed for 5 minutes with 15 wt% water to form a consistency suitable for extrusion. Solid green bodies were formed by pressure casting into a 20 cm x 10 cm x 5 cm form and subsequently dried in air at room temperature for 24 hours and at 76° C. for another 24 hours. After drying, the green solid bodies were heat treated in an electric kiln at 1070° C. for 4 hours. Standard brick manufacturing procedures would also include de-airing the wet mix before extrusion, thus increasing the green density of the formed solid. After heat treatment, the samples exhibited a water absorption of 9%, per ASTM standard testing methods. X-ray diffraction analyses confirmed that forsterite was still the primary solid phase after heat treatment, along with minor amounts of quartz and hematite. Scanning Electron Microscopy and Energy Dispersive X-ray Spectroscopy performed on the samples after heat treatment confirmed the presence of forsterite and small surface grains of hematite.

### Example 3 - Ceramic Brick/Paver With Larger Particle Size and Higher Heat Treatment

A composition and heat treating protocol (aka firing or sintering) was evaluated for producing a ceramic brick or paver containing olivine as the reactive solids.

Commercial olivine (i.e., AGSCO LE30) was acquired and was determined to be forsterite (Mg₂SiO₄) with nominally 9% fayalite (Fe₂SiO₄). The particle size distribution was single mode with largest dimensions in a range of about 355 µm to about 500 µm.

About 30 wt% of olivine was mixed with about 70 wt% clay mined near Piedra Negras, Mexico resulted in a dry mixture with less than 5 wt% of coarse particles (nominally 0.5 mm) secondary to the clay material. The dry mixture was subsequently mixed for 5 minutes with 30 wt% water to form a consistency that allows for extrusion forming.

Solid green bodies were formed by pressure casting into a 20 cm x 10 cm x 5 cm form and subsequently dried in air at room temperature for 24 hours and at 76° C. for another 24 hours. After drying, the green solids were heat treated in an electric kiln at 1120° C. for 4 hours. Standard brick manufacturing procedures would also include de-airing the wet mix before extrusion, thus increasing the green density of the formed solid.

After heat treatment, the samples exhibited a water absorption of 5%, per ASTM standard testing methods. The lower water absorption can be attributed to the higher temperature during heat treating as well as the larger particle size distributions present in the clay and olivine starting materials leading to higher green densities.

### Example 4 - Glass-Ceramic Tile

A composition and heat treating protocol (aka firing or sintering) was evaluated for producing a glass-ceramic tile containing olivine as the primary reactive solids.

Commercial olivine (Sibelco No. 11 PO) was acquired and was determined to be forsterite (Mg₂SiO₄) with nominally 8% fayalite (Fe₂SiO₄). The particle size distribution was single mode centered around 50 µm which results in faster reaction times than the compositions of Examples 1-3, which had significantly larger particle sizes. Additionally, replacing clay with glass powder significantly reduces the heat treatment temperatures necessary for densification and microstructure development. In this case, a standard container glass containing Na₂O, CaO, and SiO₂ as the primary composition was high energy ball milled to a particle size of approximately 44 mm.

Mixing 50 wt% olivine with 50 wt% recycled glass powder resulted in a dry mixture with poor green strength. The dry mixture was subsequently mixed on a ball mill for 24 hr with 4 wt% of a water and polymethymethacrylate mixture to act as a binder, thus adding green strength to the formed body. The binder is sacrificial and combusts during the heat treatments, leaving no residual organics in the final object. Solid green bodies were formed using uniaxial pressing at about 300 MPa and subsequently heat treated in an electric kiln at about 800° C. for about 10 minutes followed by a glass annealing hold at 510° C. for about 20 minutes. After heat treatment, the samples exhibited a water absorption of 3%, per ASTM standard testing methods. X-ray diffraction analyses confirmed that forsterite was still the primary solid phase after heat treatment, along with an amorphous glass phase. Scanning Electron Microscopy and Energy Dispersive X-ray Spectroscopy performed on the samples after heat treatment confirmed the presence of forsterite and small surface grains of hematite.

### Example 5 - Glass-Ceramic Tile With Devitrification Heat Treatment

Using the same composition and forming methods as Example 4, a secondary heat treatment is applied to the sample following the highest temperature densification step (800° C. hold). In this example, the sample is held at 590° C. for more than 24 hours in order to devitrify the glass. This devitrification step will precipitate other reactive solids such as wollastonite and devitrite from the glass phase, thus increasing the CO₂ absorption rate and capacity of the object. X-ray diffraction following devitrification heat treatment confirmed the presence of these additional reactive solids.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A sacrificial ceramic CO₂ sequestration architectural product, the sacrificial ceramic CO₂ sequestration architectural product comprising a sintered/heat-treated mixture that comprises:
one or more reactive solid phases at a total relative amount in a range from about 30 wt% to about 70 wt% of the sintered/heat-treated mixture, wherein each reactive solid phase comprises one or more weathering materials, wherein each weathering material is Mg—, Ca—, and/or Na-rich (greater than 40 atomic % of the cations of the weathering materials), Si-poor (less than 55 atomic % of the cations of the weathering materials), and capable of enhanced mineralization, and wherein each reactive solid phase has a median grain size in a range from about 10 µm to about 500 µm and a single mode grain size distribution such that one standard deviation is ± 10% of the median grain size; and
one or more particle-bridging phases that bridge the one or more reactive solid phases, wherein the one or more particle-bridging phases are at a total relative amount in a range from about 30 wt% to about 70 wt% of the sintered/heat-treated mixture; and
an open porosity (determined by ASTM C830) that is in a range from about 15 vol% to about 30 vol%.

2. The sacrificial ceramic CO₂ sequestration architectural product of claim 1, wherein the one or more reactive solid phases are at a total relative amount in a range from about 50 wt% to about 70 wt% of the sintered/heat-treated mixture, and the one or more particle bridging phases are at a total relative amount in a range from about 50 wt% to about 70 wt% of the sintered/heat-treated mixture.

3. The sacrificial ceramic CO₂ sequestration architectural product of claim 1, wherein the magnesium, calcium, and/or sodium of the one or more weathering materials are at a total concentration in a range from about 40 atomic % to about 100 atomic % of the cations of the weathering materials.

4. The sacrificial ceramic CO₂ sequestration architectural product of claim 1 consisting of the sintered/heat-treated mixture.

5. The sacrificial ceramic CO₂ sequestration architectural product of claim 1, wherein the one or more weathering materials are selected from the group consisting of olivine ((Mg,Fe)₂SiO₄), forsterite (Mg₂SiO₄), monticellite (CaMgSiO₄), calarnite (Ca₂SiO₄), wollastonite (CaSiO₃), merwinite (Ca₃MgSi₂O₈), bredigite (Ca₇MgSi₄O₁₆), basalts, other ultramafic minerals, and combinations thereof.

6. The sacrificial ceramic CO₂ sequestration architectural product of claim 1, wherein the one or more weathering materials is olivine ((Mg,Fe)₂SiO₄).

7. The sacrificial ceramic CO₂ sequestration architectural product of claim 1, wherein the one or more particle-bridging phases comprise one or more bridging materials selected from the group consisting of one or more clays, one or more feldspars, quartz, corundum, one or more soda lime glasses, one or more other glasses, combinations thereof, and reaction products thereof.

8. The sacrificial ceramic CO₂ sequestration architectural product of claim 6, the one or more bridging materials are selected from the group consisting of one or more clays and reaction products thereof.

9. The sacrificial ceramic CO₂ sequestration architectural product of claim 6, wherein the one or more bridging materials are selected from the group selected from the group consisting of a combination of one or more clays and one or more feldspars, and reaction products of said combination.

10. The sacrificial ceramic CO₂ sequestration architectural product of claim 9, wherein the combination of one or more clays and one or more feldspars is such that the combination has a relative amount of the one or more clays that is in a range from about 50 wt% to about 67 wt% of the combination and a relative amount of the one or more feldspars that is in a range from about 33 wt% to about 50 wt% of the combination.

11. The sacrificial ceramic CO₂ sequestration architectural product of claim 6, wherein the one or more bridging materials are selected form the group consisting of one or more soda lime glasses, and reactions products of said one more soda lime glasses.

12. The sacrificial ceramic CO₂ sequestration architectural product of claim 1, wherein the sintered/heat-treated mixture has at least one major surface configured to have an effective surface area that is in a range from 20% to about 100% greater than a nominal macroscale area of said at least one major surface.

13. A process for making a sacrificial ceramic CO₂ sequestration architectural product that comprises a sintered/heat-treated mixture, the process comprising:
creating a mixture that comprises:
particles of one or more weathering materials and a binder, wherein the one or more weathering materials are at total relative amount that is in a range from about 30 wt% to about 70 wt% of the mixture solids, and wherein each weathering material is Mg—, Ca—, and/or Na-rich (greater than 40 atomic % of the cations of the weathering materials) and Si-poor (less than 55 atomic % of the cations of the weathering materials), and capable of enhanced mineralization, and wherein each weathering material has a median particle size in a range from about 10 µm to about 500 µm and a single mode particle size distribution (determined using sieve (ASTM C371-09), microscopy (ISO 13322-2), or laser scattering (ASTM 1070-01 or ISO 13320-1)) such that one standard deviation is ± 10% of the median grain size; and
particles of one or more bridging materials, wherein the one or more bridging materials are at total relative amount that is in a range from about 30 wt% to about 70 wt% of the mixture solids, and wherein the one or more bridging materials are selected from the group consisting of one or more clays, one or more feldspars, quartz, corundum, one or more soda lime glasses, one or more other glasses, combinations thereof;
forming the mixture; and
heating the formed mixture to yield the sintered/heat-treated mixture, wherein the sintered/heat-treated mixture comprises:
one or more reactive solid phases at a total relative amount in a range from about 30 wt% to about 70 wt% of the sintered/heat-treated mixture, wherein each reactive solid phase comprises one or more weathering materials, wherein each weathering material is Mg—, Ca—, and/or Na-rich (greater than 40 atomic % of the cations of the weathering materials), Si-poor (less than 55 atomic % of the cations of the weathering materials), and capable of enhanced mineralization, and wherein each reactive solid phase has a median grain size in a range from about 10 µm to about 500 µm and a single mode grain size distribution such that one standard deviation is ± 10% of the median grain size; and
one or more particle-bridging phases that bridge the one or more reactive solid phases, wherein the one or more particle-bridging phases are at a total relative amount in a range from about 30 wt% to about 70 wt% of the sintered/heat-treated mixture; and
an open porosity (determined by ASTM C830) that is in a range from about 15 vol% to about 30 vol%.

14. The process of claim 13, wherein the formed mixture is heated to temperature(s) for sufficiently high densification and microstructure development of the sintered/heat-treated mixture but not so high as to degrade the weather materials’ capability of enhanced mineralization.

15. The process of claim 13, wherein the formed mixture is heated to temperature(s) in a range from about 900° C. to about 1125° C. for a duration in a range from about 4 hours to about 48 hours.

16. The process of claim 13, wherein the one or more weathering materials are at a total relative amount that is in a range from about 50 wt% to about 70 wt% of the mixture solids, and the one more bridging materials are at a total relative amount that is in a range from about 50 wt% to about 70 wt% of the mixture solids.

17. The process of claim 13, wherein the one or more weathering materials are selected from the group consisting of olivine ((Mg,Fe)₂SiO₄), forsterite (Mg₂SiO₄), monticellite (CaMgSiO₄), calarnite (Ca₂SiO₄), wollastonite (CaSiO₃), merwinite (Ca₃MgSi₂O₈), bredigite (Ca₇MgSi₄O₁₆), basalts, soda lime glass, other ultramafic minerals, and combinations thereof.

18. The process of claim 13, wherein the one or more weathering materials is olivine ((Mg,Fe)₂SiO₄).

19. The process of claim 18, wherein the one or more bridging materials is one or more clays.

20. The process of claim 18, wherein the one or more bridging materials is a combination of one or more clays and one or more feldspars.

21. The process of claim 20, wherein the combination of one or more clays and one or more feldspars has a relative amount of the one or more clays that is in a range from about 50 wt% to about 67 wt% of the combination and a relative amount of the one or more feldspars that is in a range from about 33 wt% to about 50 wt% of the combination.

22. The process of claim 18, wherein the one or more bridging materials is one or more soda lime glasses.

23. The process of claim 13, wherein the binder comprises water and the process further comprises drying the formed mixture.

24. The process of claim 13, wherein the forming of the mixture comprises configuring the formed mixture so that the sintered/heat-treated mixture has at least one major surface configured to have an effective surface area that is in a range from 20% to about 100% greater than a nominal macroscale area of said at least one major surface.
